(19) United States
(12) Patent Application Publication
(10) Pub. No.: US 2011/0088292 A1
(43) Pub. Date: Apr. 21, 2011

(54) TOY AND/OR PACKAGING AND / OR OTHER ITEM INCLUDING A LIGHT ILLUMINATION SYSTEM

(76) Inventors: Robert Kay, Macceslfield (GB); Ross Worthington, Macceslfield (GB)

(21) Appl. No.: 12/757,097

(22) Filed: Apr. 9, 2010

(30) Foreign Application Priority Data
Oct. 16, 2009 (GB) 0918191.8
Jan. 20, 2010 (GB) 1000929.8

(51) Int. Cl. G09F 13/00; F21V 8/00; G09F 1/00; B65D 79/00; B43L 13/18

(52) U.S. Cl. 40/124.02; 362/615; 362/616; 362/628; 40/541; 40/442; 206/457; 30/164.9

(57) ABSTRACT

The invention relates to the provision of a toy and/or packaging and/or another item which includes a light illumination system to allow one or more features provided on at least one sheet of material provided as part of the item, to be rendered more viewable when the light sources are illuminated. The feature is formed on a surface of the sheet material and into the same, typically by etching or another material removal operation. Animated effects can be created by the sequential illumination of the light sources. Audio means can also be provided to be operated in conjunction with the light sources.

The invention to which the application relates is a toy and/or packaging and/or other item, which includes a light illumination system which allows particular visual effects to be created to be viewed by the user of the toy and/or packaging and/or other item and, furthermore, to provide the visual effects in a manner which are relatively low cost, and thereby enable the same to be used in relatively low cost items such as the toy, or packaging, or other items such as greetings cards, books or the like.

The use of light sources in combination with an item, to create a particular visual feature of the item is known. Typically, the visual effect which is created, is achieved by the location of a light source behind a particular feature or part of the toy and then the selective illumination of the light source changes the appearance of the feature of the toy such as, for example, to make the same brighter when the light source is illuminated.

Although the use of light sources to provide this form of visual effect, is known, the range of uses of the same, has, until now, been relatively limited which, in turn, means that toys that incorporate light sources, can be regarded immediately, or after relatively limited use, as being predictable and therefore not overly attractive to a child.

It is also known to provide display apparatus comprising a plurality of light sources in conjunction with a series of layers of sheet material so as to provide a display.

The aim of the present invention is to provide a means whereby the use of light sources in relation to a toy, packaging, or other item can be achieved in a manner which allows at least a portion of the item to have its appearance changed by the selective illumination of the light sources and also to enable the portion which has its features changed to be formed so as to determine the manner of the defined change of appearance. A further aim of the present invention is to provide a means by which this form of display is utilised in a novel and inventive manner so as to provide advantages and benefits in items not previously envisaged. A yet further aim of the invention is to provide apparatus which allows the user to define and create the features which are to be illuminated.

In a first aspect of the invention there is provided apparatus having a display portion formed of sheet material, at least one light source located at an edge of the said sheet material and positioned such that, when illuminated, light is passed into the sheet material from said edge and said sheet material includes at least one feature which depends from a surface into the sheet material such as to cause a change of direction of said light at the location of said feature such that when said light source is illuminated, the visibility of said feature is increased at said surface.

In one embodiment the said feature is created by an etching or similar process to pass into the sheet material from a surface thereof.

In one embodiment, the direction of the light path is changed by the feature such that the light passes through the feature towards the surface in which the feature is formed to be externally visible from at least one of the planar surfaces of the said sheet material. Typically said sheet material is substantially optically transparent or clear so as to allow the light to pass therethrough and through at least one of the planar surface where the at least one feature is provided.

In one embodiment, the feature is formed by removing at least a portion of material from one of the planar surfaces of the sheet material, to a depth into the sheet material. Typically the feature does not pass through the sheet material.

In one embodiment a plurality of portions of sheet material are provided. In one embodiment, the said sheet material is placed side by side. Typically each portion of sheet material is provided with a light source therefore.

In an alternative embodiment, the portions of sheet material are placed so as to overlie each other, at least partially, to provide a multilayered arrangement with each portion of sheet material provided with at least one light source therefore.

In either embodiment, the light sources which are provided for the portions of sheet material can be controlled such that the same are illuminated in a predefined manner, such as in a particular sequence, so as to provide, a changing visual effect and, in one embodiment, a particular predefined visual effect such as, for example, animation.

In this embodiment, the features which are provided on the portions of sheet material are specifically located so as to allow the desired animated effect to be achieved by sequential illumination of the light sources. For example, a feature on a first piece of sheet material is first illuminated followed by illumination of a second feature on a second piece of sheet material and so on with the locations of the features selected so as to provide the specified animated effect.

In one embodiment, a single light source is provided which can be operated to provide different colours and/or intensity of light or, alternatively, a plurality of light sources are provided which may be of different light intensity and/or colour and/or which may be operated in a controlled manner so as to provide a particular visual effect.

Typically, the light source is an LED light source or an infra red light source.

In one embodiment, the sheet material is provided in a substantially flat form or alternatively, may be provided in a 3D shape, with the shape selected being such as to still allow light to pass through the same until a feature is reached.

In one embodiment, the feature or features are created on the sheet material by any or any combination of machining, shot blasting, drilling, scoring, etching, texturing, extrusion and/or moulding.

In one embodiment, the said apparatus is a toy and the portion or portions of sheet material are provided as an integral part of said toy or provided as part of the overall toy. The one or more light sources for illumination of the sheet material are preferably located within the toy so as to be hidden from view and thereby allow, when illuminated, a surprising visual effect to be created on the sheet material and hence, on the toy.

In a further embodiment, the apparatus is provided as part of an item of packaging with, in one embodiment the packaging having a housing in which an article, such as a toy, is located for retail purposes.

In this aspect, the packaging housing is at least partially formed of sheet material which is illuminated by at least one light source provided as part of the packaging. In a first use, the selective operation of the light source is possible while the article is still a retail pack, thereby allowing a visual effect to be created and be viewable by a person considering buying the retail pack and the toy therein.

In a further embodiment, the item of packaging may still thereafter be used once the retail pack has been purchased as part of the toy itself.

In a further aspect of the invention, there is provided a retail pack, said pack including an item for use, once purchased, and packaging in which said item is at least partially housed so as to form the retail pack, said packaging including at least a portion formed of overlaid first and second layers of sheet material, at least one of said sheets including a feature formed in a surface of the same, and at least one light source is provided which, when illuminated, passes light into at least one of said layers of sheet material so as to provide an illuminating effect on the at least one feature formed therein.

In one embodiment, a first set of light sources are provided to provide a lighting effect on a first layer of sheet material and a second set of light sources are provided to provide a lighting effect on a second layer of sheet material.

In one embodiment, the said sets of light sources for the layers of sheet material are selectively controlled so as to be illuminated in sequence so as to provide a particular visual effect.

In one embodiment, the light sources are located as part of the packaging or, alternatively, the light sources are provided as part of or for use with the item located within the packaging.

In one embodiment, when the light sources are provided as part of, or for use with, the item the same can be provided in a first location for use with the packaging and a second location for use with the item, typically by moving part of the item in which the light sources are located.

In one embodiment, the packaging or item includes user actuation means such that, when in the form of a retail pack, a prospective purchaser of the retail pack can operate the actuation means to cause the illumination of the packaging and therefore make the retail pack more attractive or illustrate a particular feature of the item held therein. Furthermore, when the light source or sources are located on the item within the packaging, the item itself can appear to be more attractive to a potential purchaser.

In one embodiment, once the item has been removed from the packaging, the light source or sources on the item, can continue to be used to provide a light effect on the item itself.

In a further aspect of the invention, there is provided an item, said item including a display portion formed by at least first and second overlaid sheets of material, one or more light sources provided for selective illumination of one or more of the layers of the sheet material and wherein at least one of the sheets of material has at least one feature formed into a surface thereof and, the illumination of the one or more light sources for that layer of sheet material, cause the illumination of the said at least one feature so as to provide a visual effect.

In one embodiment the item is provided in the form of a greetings card.

Typically control means are provided so as to cause the selective illumination of sets of light sources for each layer of the sheet material so as to provide an animated effect.

In one embodiment, the control means are operated by the movement of the greetings card from a closed position to an open position and, in which open position, the layers of sheet material are visible.

In whichever aspect of the invention, in one embodiment, audio means are provided to be operated in conjunction with the illumination of the light sources so as to provide sound effects which are preferably in sequence, and synchronised, with the visual effects which are created by the selective illumination of the light sources.

In a further aspect of the invention, the item is a book or other published material, with the same including a portion formed with the layers of sheet material and a plurality of light sources in a manner as previously described.

In a yet further aspect of the invention, there is provided apparatus having a display portion formed of at least one layer of sheet material, at least one light source located at an edge of the said at least one layer of sheet material and positioned such that, when illuminated, light is passed into a sheet material from said edge, said apparatus further including the means for forming a feature to a depth into the said sheet material and said feature selectively formed and located on the sheet material by the user of the apparatus using the said means such that when said light source is illuminated, the visibility of the feature which has been formed, is increased at said surface.

In one embodiment, the means for creating the feature, is an etching tool which, when drawn across the surface, causes a portion of the material to be removed to create the feature to a shape defined by the user of the tool.

In one embodiment, the said tool includes an assembly which, when the pressure exerted on the etching tip of the tool exceeds a predetermined level, the etching tip is rendered unusable.

In one embodiment, the tip of the etching tool is rendered unusable by the same being retracted or withdrawn into the tool.

In one embodiment, the display portion is formed from a plurality of sheets of material which can be selectively positioned one over the other to form the display which is to be illuminated. Typically, prior to doing so, those layers of the sheet material which are required to have a feature formed thereon, can be positioned on the apparatus in conjunction, in one embodiment in combination with a stencil on which one or more features are depicted, and the user can follow the lines of said depicted features with an etching tool on the layer of sheet material so as to form the feature.

Specific embodiments of the invention are now described with reference to the accompanying drawings; wherein

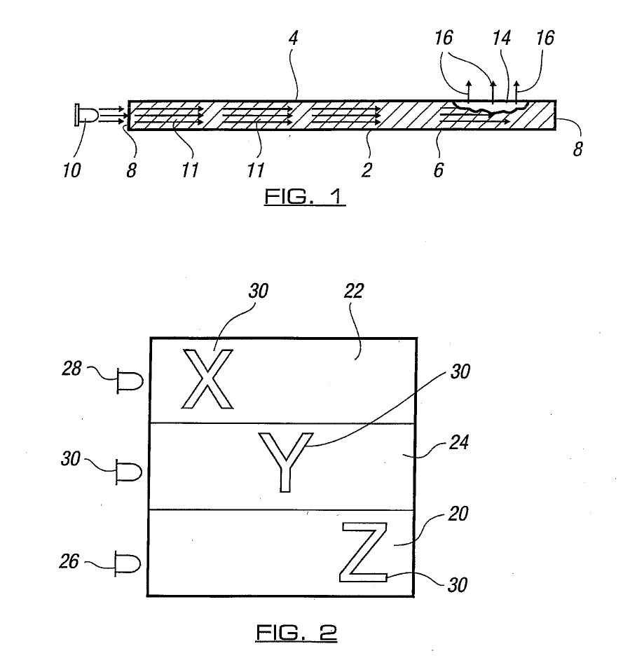

FIG. 1 illustrates sheet material and a light source in schematic fashion in accordance with the invention;

FIG. 2 illustrates an embodiment of the invention;

FIG. 3 illustrates a further embodiment of the invention;

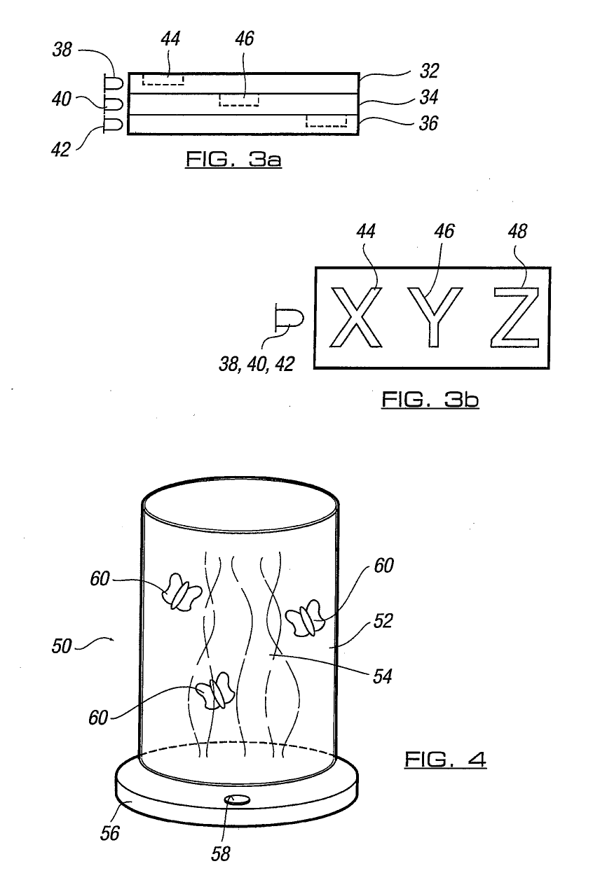

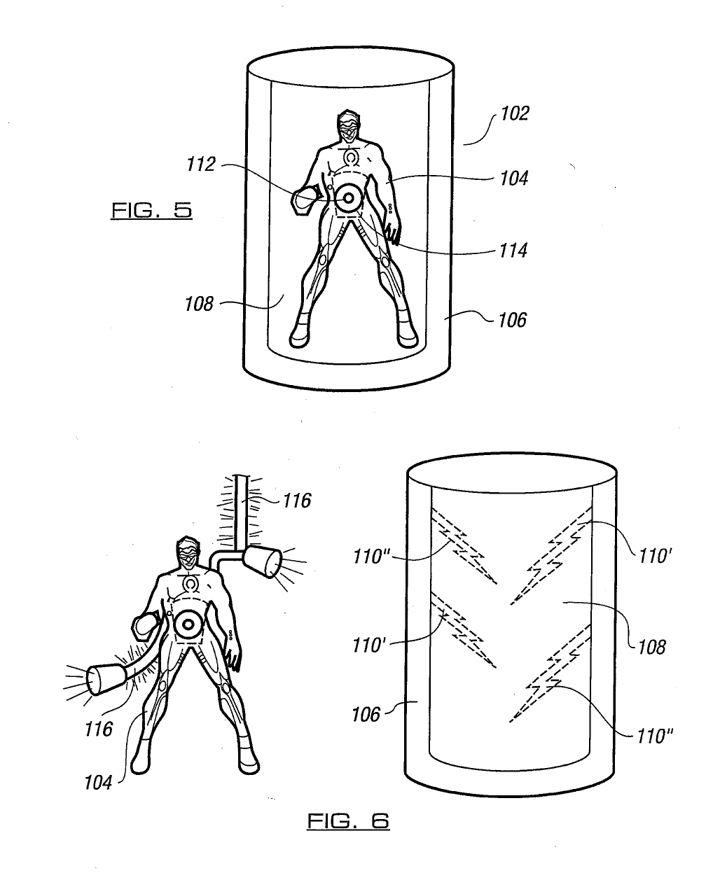

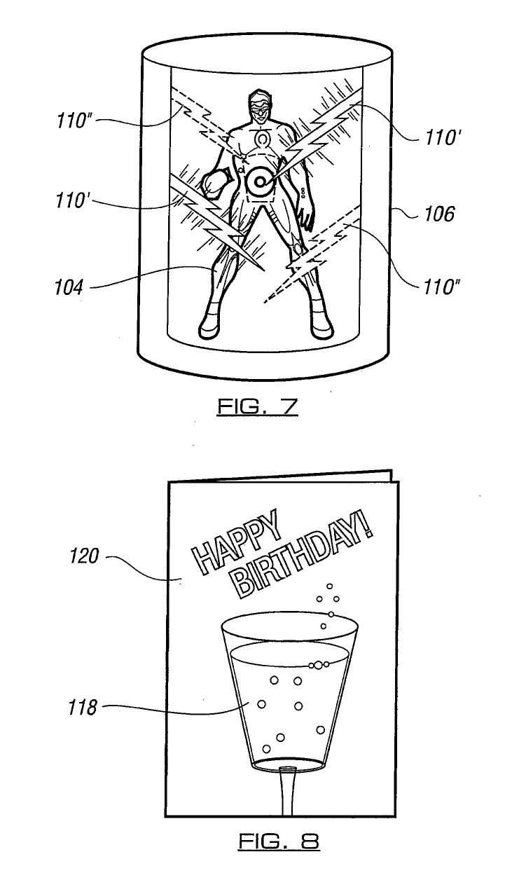

FIG. 4 illustrates an item of packaging in accordance with one embodiment in the invention;

FIG. 5 illustrates a retail pack in accordance with one embodiment of the invention;

FIG. 6 illustrates the retail pack with features of the same illuminated in accordance with the invention;

FIG. 7 illustrates the item of the retail pack removed therefrom;

FIG. 8 illustrates a greeting card in accordance with an aspect of the invention in a first position;

FIG. 9 illustrates the greeting card in accordance with FIG. 4 in a second position;

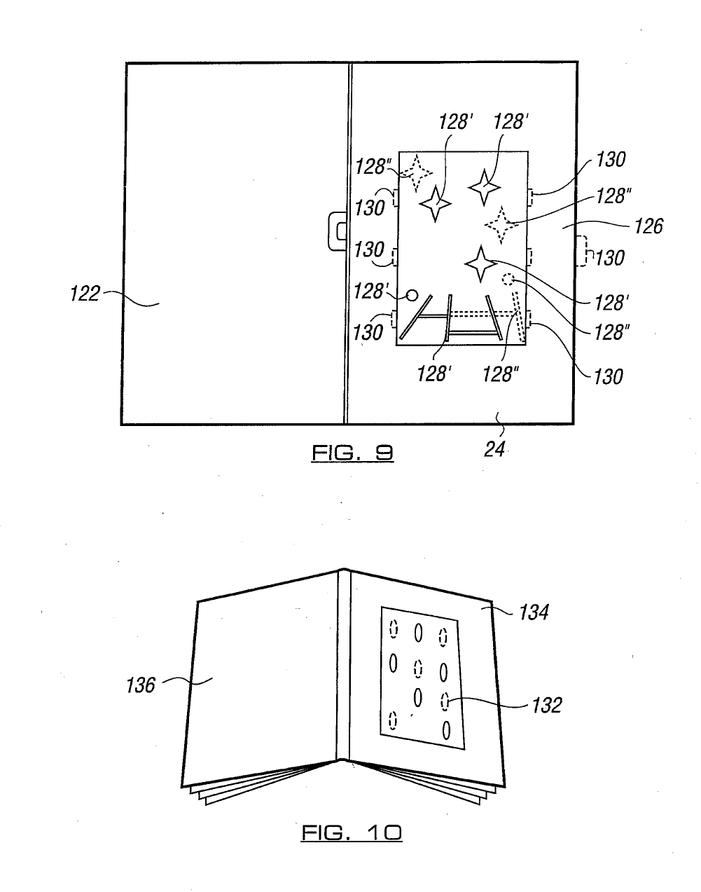

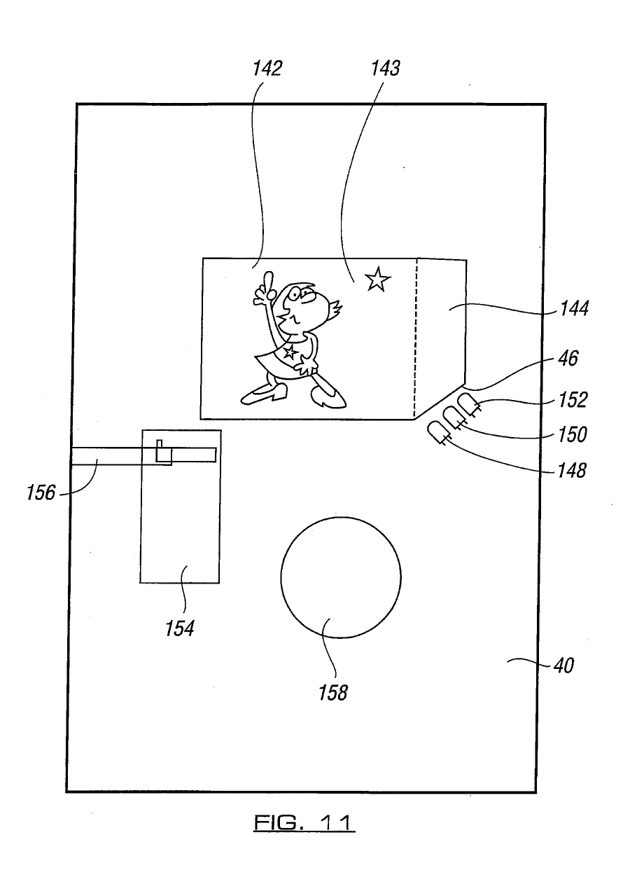

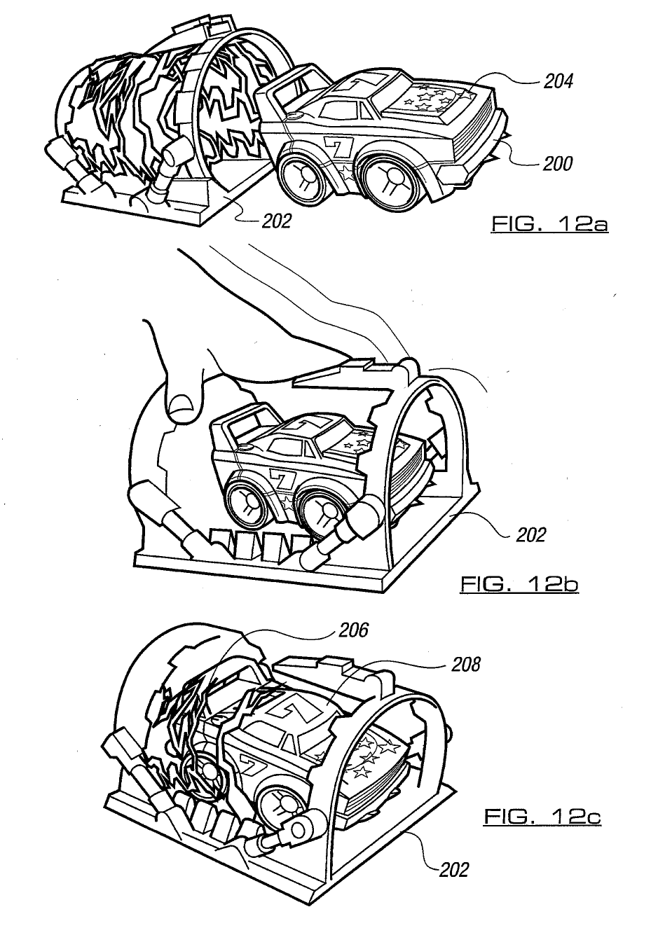

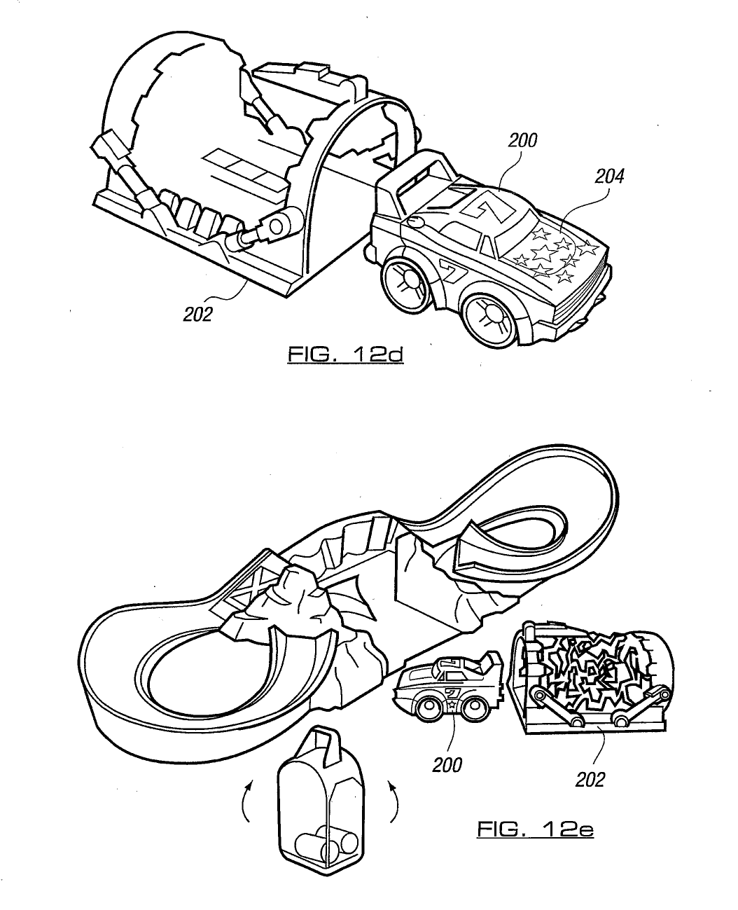

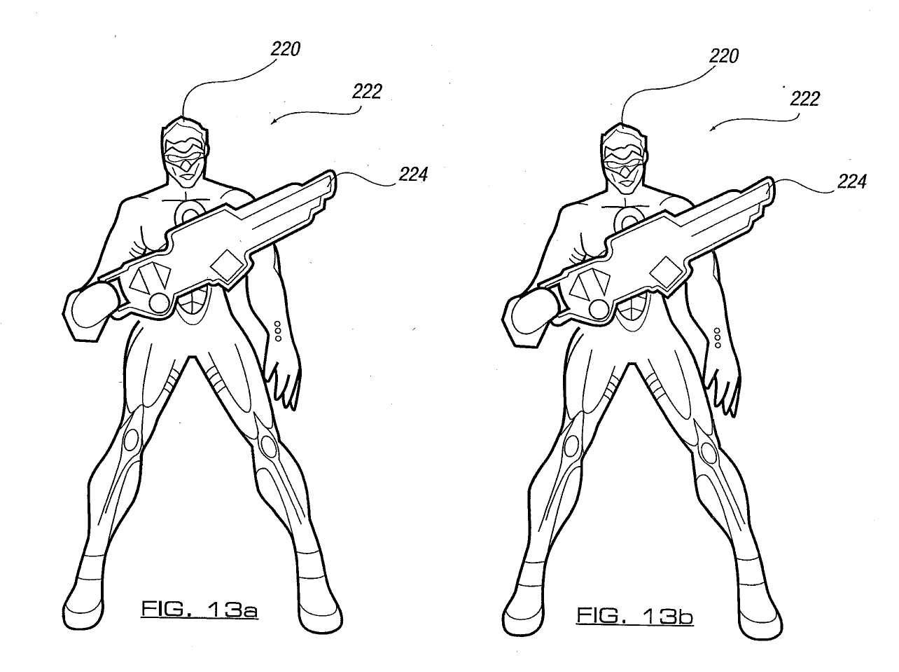

FIG. 10 illustrates a further aspect of the invention;

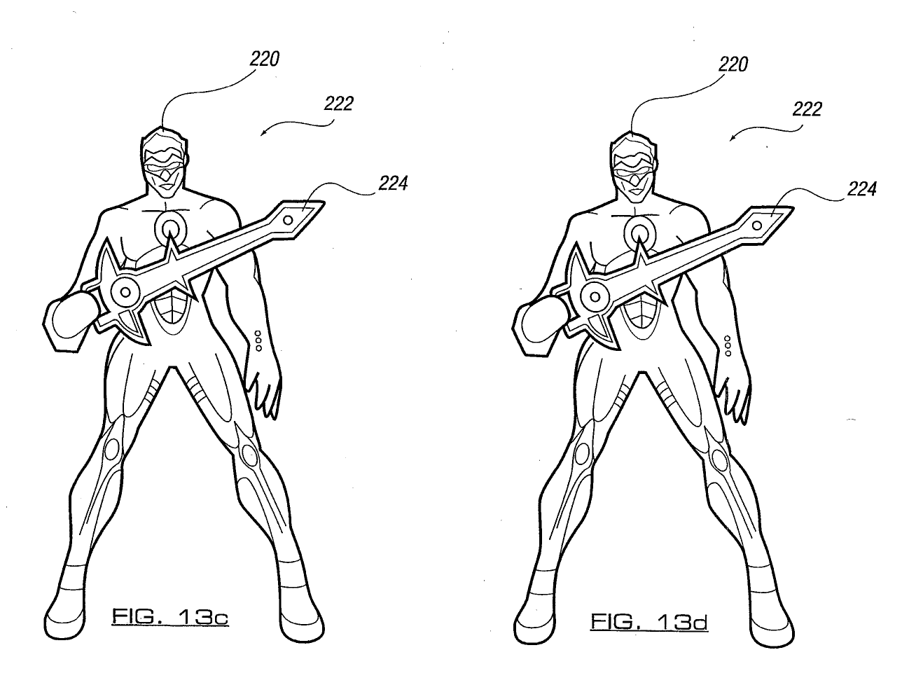

FIG. 11 illustrates a further illustration of the invention in use.

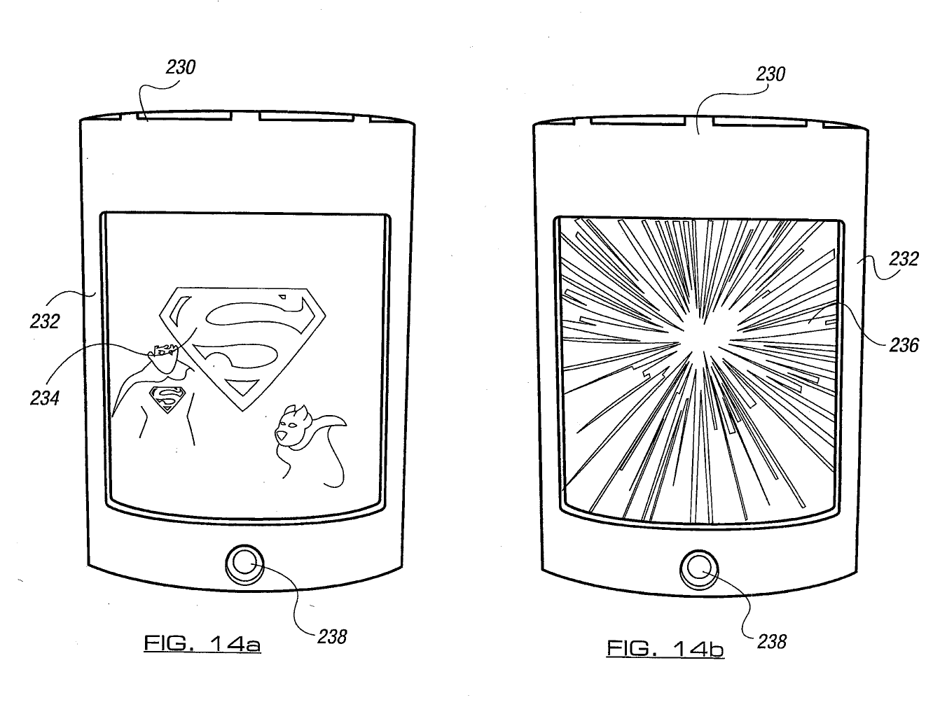

FIGS. 12a-e illustrates a further embodiment of an item in accordance with the invention;

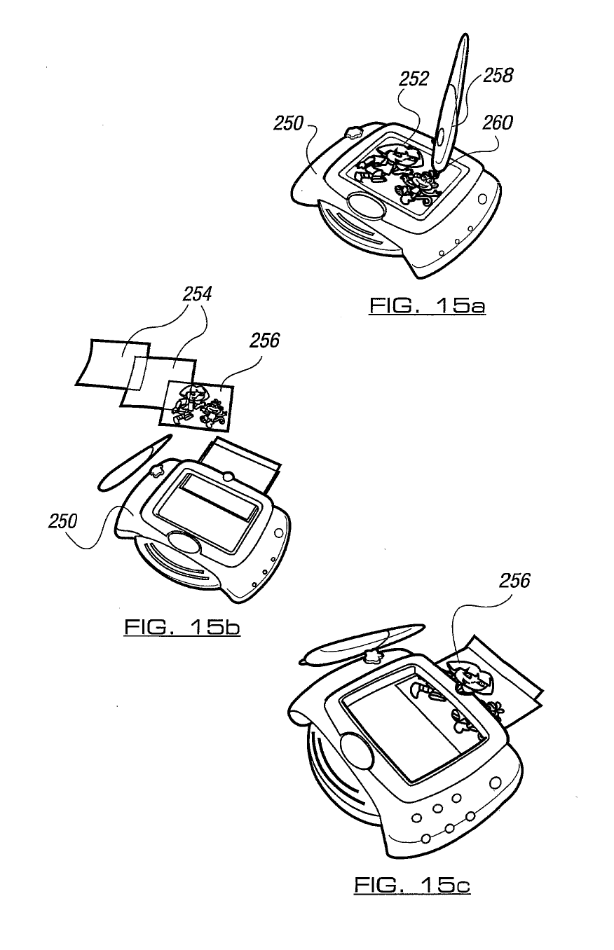

FIG. 13a-d illustrate further arrangements of an item in accordance with the invention;

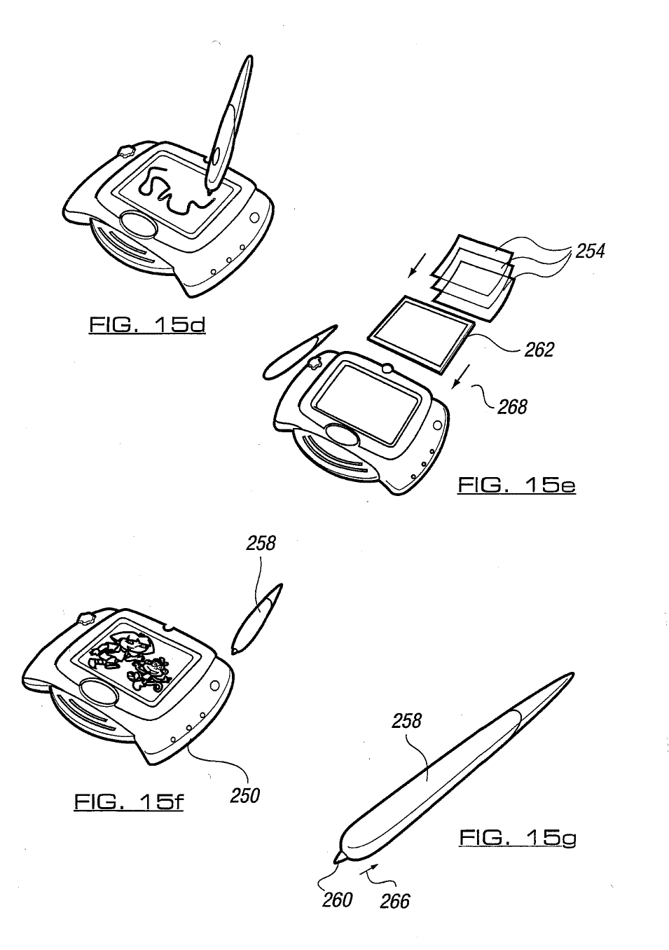

FIGS. 14a and b illustrate packaging in accordance with an embodiment of the invention;

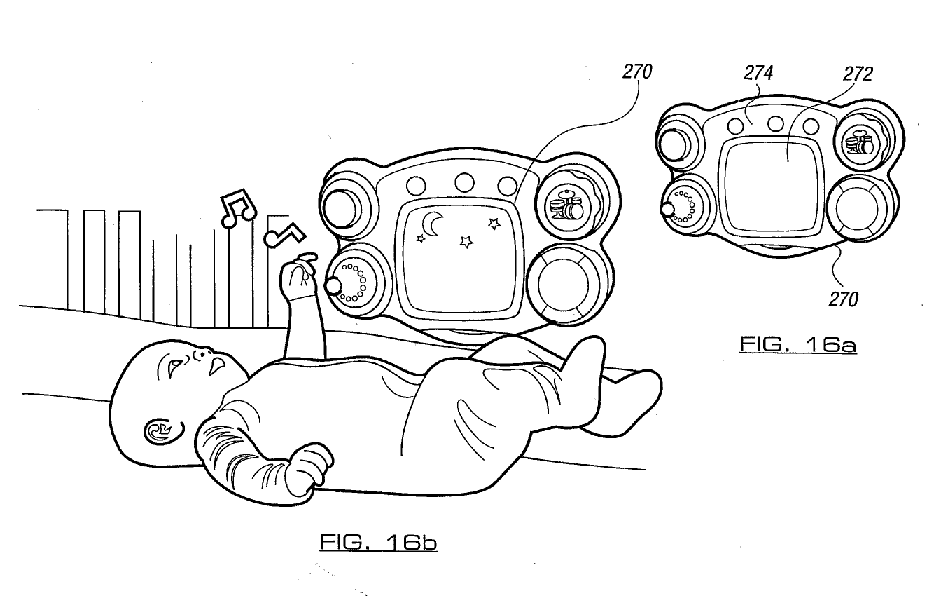

FIGS. 15a-g illustrate yet a further embodiment of the invention; and

FIGS. 16a and b illustrate a yet further embodiment of the invention.

Referring firstly to FIG. 1, there is illustrated, in schematic fashion, one embodiment of the invention. The invention operates by providing at least one portion of sheet material 2 which has opposing planar surfaces 4, 6 and side edges 8. There is also provided a light source 10 which is located with regard to the sheet material such that at least some of the light 12 emitted from the same, when illuminated, passes into the sheet material via a side edge 8. The light therefore continues in a path through and across the sheet material as indicated by light path arrows 11. The illumination which is visible from the planar surfaces 4, 6, is relatively low until the light reaches a feature 14 which has been formed in the sheet material and which feature depends inwardly from one of the planar surfaces 4 of the sheet material. It should be appreciated that although the light path arrows 11 are shown as straight this is to illustrate the “general” path followed by the light. However in practice the light will bounce off and move between the planar surfaces 4, 6 within the sheet material, as if reflected off a mirrored surface and therefore the actual path is more likely to be in a “zigzag” manner. When the light arrives at the feature 14 the feature acts to “absorb” i.e. does not reflect back, the light and so the light, and hence feature, is visible from at least one of the planar faces and typically the one into which the feature is formed, such that the feature shape is particular clearly illuminated and hence visible. It is also the case that when the light source is not illuminated the feature is typically substantially indistinguishable, and hence the illumination of the same to be visible can be used to provide a surprising event, particularly to a child.

The feature 14 is typically formed by texturing the sheet material from at least one of the planar surfaces so as to remove at least a portion of the sheet material and hence cause the feature to have a depth which allows a portion of the light path 11 passing through the sheet material to change direction as indicated by 16. This change of direction causes the illumination of the feature to be viewable from the planar surface at the feature 14 location and hence the visibility of the feature to be greatly increased with respect to the illumination viewable from the remainder of the surface 4 and hence a specific visual effect is created in which the feature shape is particularly visible. Typically, the feature shape will be linked to the item with which the sheet material is provided, such as a feature of a toy. It also means that the feature, which is relatively invisible when the light source is switched off becomes clearly, and surprisingly visible when the light source is switched on.

Turning now to FIG. 2, there is illustrated a particular embodiment of the invention. In this case, there is provided a plurality of portions of, sheet material 20, 22, 24 placed side by side and a light source 26, 28, 30 is provided for the respective portions of sheet material. Control means are also provided (not shown) to allow the selective and/or sequential illumination of the light sources. Each of the portions of the sheet material, has at least one feature 30 formed thereon and the particular shape and/or location of the feature is selected so that, in combination with the selected operation of the light sources, a particular visual effect can be created. It is also possible that other aspects of the item can be provided to operate in conjunction with the light sources, such as, sound. Typically, the light sources will be of different light intensity and/or colour so as to allow further options for the visual effect which can be created.

FIGS. 3 a and b illustrate an elevation and plan of a further arrangement according to an embodiment of the invention in which there is again provided a number of portions of sheet material 32, 34, 36 but in this, the portions are provided in a multi layer arrangement. Again, a light source 38, 40, 42 is provided for each of the portions of sheet material to allow light emitted there from to pass along a specific sheet material portion. The light sources may have different degrees of illumination, intensity and/or colour and again can be operated in sequence such, that at any given time, one or a specific combination of features on the sheet material are illuminated. Furthermore, the features which are formed on each of the pieces of sheet material can be selectively formed and positioned with respect to each other and the portions of sheet material so as to provide, as illustrated in FIG. 3b, in combination with the sequential illumination, an animation effect, in which, in the example given, feature 44 will first be illuminated, via light source 38, followed by the illumination of the sheet material on which feature 46 is formed by the light source 40, followed by illumination of feature 48 by the selective operation of the light source 42.

FIG. 4 illustrates a further embodiment of the invention and in this case the sheet material is provided as an item of packaging 50 with an enclosure or housing 52 in which an item can be held so as to form a retail pack, such as for example, a toy 54 may be provided within the sheet material enclosure. In this case, light sources (not shown) are located in the base 56 of the packaging but may also be provided in the top and/or sides of the packaging or on the item within the package. The light sources are provided to be illuminated upon the pressing of one or more actuating means 58 provided as part of the packaging. In this case, the features 60 formed on the sheet material can illustrate particular aspects of the toy 54 which is being sold therein and can be provided as a “Try Me” promotional feature in which the child, by pressing the actuating means 58, causes the illumination of the sheet material to illuminate the specific features. It should be appreciated that the operation of the same is in the same manner as previously described with regard to FIGS. 1-3. In addition, the sheet material packaging may also be used as a feature of the item therein once purchased so as to provide further play opportunities for the child.

Referring now to FIGS. 5-7, there is illustrated a further embodiment of a retail pack in accordance with one aspect of the invention. The retail pack 102 includes an item 104 which is held within packaging 106 in the form of a housing. The item in this case is a toy character although it should be appreciated that the item within the packaging can be of any form. The packaging comprises a window or display portion 108 formed, in this embodiment from first and second layers of transparent sheet material which are overlaid to form the window 108 through which the item 104 can be viewed. At least one, but typically both, of the layers of sheet material include features formed therein. The features depend inwardly from a surface of the sheet material. Typically, the features 110, which in this case are in the form of lightning bolts, are formed in each of the layers of sheet material and overlaid such that a particular visual effect can be subsequently created.

A plurality of light sources are located to be selectively illuminated upon operation of the actuation means 112 which in this case are provided on the item 104 and can be accessed via aperture 114 in the packaging window 108 and, when illuminated, the light sources illuminate at least one of the sheets of material. Thus, for example, a first set of light sources in the form of LED's, are provided to be selectively illuminated and illuminate a first layer of the sheet material and make the features 110′ on that layer visible as shown in FIG. 6. A second set of LED's are positioned to be selectively illuminated to illuminate the second sheet of material which, when illuminated, will cause the features 110″ to be visible. It is found that when the light sources are illuminated, the features which have been formed in the sheet material are particularly distinctive as the same depend into the sheet material and the impact of the light on the same makes these features particularly viewable. This, in turn, renders the packaging window 108 particularly distinctive.

By allowing for the selective illumination of the different sets of LED's, so an animated effect can be created on the packaging and typically, the visual effect which is created, is linked to the item held within the packaging so as to make the same more appealing. In one embodiment, as shown in FIG. 7, the item 104 within the packaging 106 includes the light sources formed as part thereof or attachable thereto so the light sources can still be used in conjunction with the item once removed from the packaging. Thus, in a first configuration, the light sources 116, when the item is within the packaging, are located so as to illuminate selectively the layers of sheet material of window 108. In the second configuration as shown in FIG. 7, the light sources can be positioned to suit play with the item.

FIGS. 8-9 illustrate a further aspect of the invention in which there is provided an item in the form of a greetings card 120 which is shown in a closed position in FIG. 8 with a front face carrying a graphical design 118 thereon. FIG. 9 illustrates the greetings card having been opened to expose inner faces 122, 124 of the same. A portion 126 of the inner face 124, includes a visual display in accordance with the invention. The visual display is formed of first and second overlaid layers of sheet material with both layers having features 128 etched into a surface thereof and which etching depends inwardly of the sheet material.

Light sources 130 are located at the edge of said sheets of material such that when illuminated, light therefrom passes into the sheet material and impacts on the etched features 128 so as to illuminate the same and create the visual display. The selected positioning and formation of the features 128 means that illumination of a first layer of the sheet material will cause the viewing of first graphical features 128′ and then the subsequent illumination of the remaining light sources 130 will illuminate the second sheet of material and cause illumination of the features 128″ and so an animated effect is created as illustrated in FIG. 9 by the sequential illumination of the light sources. Thus, the repeated sequential illumination creates the animation effect on the visual display. In one arrangement the greetings card or indeed any other aspect of the invention can include audio means provided as part thereof which are caused to operate to create sounds which, preferably, are related to the visual effect which is being created and preferably the sounds are in synchronicity with the operation of the light sources to thereby provide a combined synchronised audio and video effect.

FIG. 10 illustrates a further aspect of the invention in which a visual display 132 is provided and incorporated within a page 134 of a book 136 so as to form a changeable visual display as part thereof.

FIG. 11 illustrates, in more detail, a sheet material 140 which may, for example, be the inner face of the greetings card, and illustrates the components which are included on or within the sheet material 140 to arrive at the invention in one embodiment. In this example there is provided a display portion or window 142 which is viewable. The display portion is formed of three, substantially transparent, sheets of material 143 which are overlaid, with the portions 144 of each masked by the material 140. At the edges 146 of the portions 144 there are provided three light sources in the form of LED's 148, 150, 152. The LED's are positioned such that, when illuminated, each will cause light to be transmitted through an edge of a respective one of the sheets 143 and across the same. The LED's can be of different colours and illuminated together or in sequence to provide an animated effect. At least one but typically each of the sheets of material will include at least one feature etched into the same, said etched feature highlighted and rendered particularly viewable by the impact of the light thereon when the LED for that sheet of material is illuminated.

The control and power for the LED's is provided via a Printed Circuit Board and batteries 154 located in the sheet material and which is rendered operable by switch means 156. In this case the switch is turned on by opening the greetings card which moves the switch. There is also provided a speaker 158 which is also powered and rendered operable via connection to the PCB and batteries 154. Typically the sounds emitted from the speaker will be synchronised with the illumination of the LED's 148, 150, 152 so as to provide an overall synchronised visual and audio animated effect.

Referring now to FIGS. 12a-e, there is illustrated an item in accordance with the invention which incorporates a first article 200 in the form of a toy model vehicle and a structure 202 which is provided to act as a housing and as a launcher for the vehicle 200. In this case, one or more light sources are provided as integral parts of the vehicle 200 and, when illuminated, act to provide a visual effect through apertures 204 in the hood of the vehicle. In addition, and in accordance with the invention the light sources are located on the vehicle such that when the vehicle 200 is located within the structure 202, as shown in FIGS. 12b and c and the lights are illuminated, light is directed from the light sources from the vehicle, and onto the edge of the sheet material which forms a wall 206 of the structure 202.

On the wall, are provided a series of features 208 which, as shown in FIG. 12b, are invisible when the lights are not on but, when the lights are illuminated the features 208 are clearly visible as shown in FIGS. 12a and c. When the light sources are extinguished or the toy vehicle is driven out of the structure, the light no longer acts on the sheet material 206 of the structure and hence the features 208 are rendered invisible again.

FIGS. 13a-d illustrate a further arrangement in which there is provided an item in the form of a character 220 which is provided for use in conjunction with an article 222 which is acted upon by light sources provided on the character 220 to illuminate features of the same. It is also illustrated how the article 222 used in conjunction with the item 220 can be changed and the specific article 222 which is in position at that time with respect to the character can be acted upon by the light sources provided within the item to illuminate the features 224 formed thereon.

FIGS. 14a and b illustrate a further item in accordance with an embodiment of the invention in which there is provided packaging 230. The packaging includes a window or display portion 232 which is formed from two overlying sheets of material which are transparent. A first layer of the material has a logo feature 234 formed on the same by etching and the other sheet of material has a series of features in the form of lines 236. FIG. 14a illustrates the packaging with the first sheet of material illuminated by a red light source. This shows up clearly the feature 234 and a lot less clearly the features on the other sheet of material. FIG. 14b illustrates how the appearance of the packaging can be changed by the illumination of the other sheet of material by a blue light source, to clearly show the line features 236 etched on the sheet of material to which the blue light source is directed. In both cases, the operation and illumination of the light sources, in sequence, is commenced by the operation of the actuation means 238 on the packaging.

FIGS. 15a-g illustrate a further aspect of the invention in which there is provided a drawing toy 250 which includes a display panel 252 which is formed of a plurality of sheets of material 254 and selectively, guide or stencil means 256 as shown in FIG. 15b. In this case, the user of the toy places stencil 256 into position in the drawing panel as shown in FIG. 15c. They then overlay this stencil with a first of the sheets of material 254 and follow the selected image on the stencil using the etching means 258 which includes a scribing or etching point 260. In another use, the stencil is dispensed with and the user can create the feature's shape “freehand”.

Typically, the etching or scribing point of the etching means is provided with an assembly such that if pressure is applied to the scribing point 260 which is greater than a predetermined level, then the scribing point is automatically retracted into the etching means body as indicated by arrow 266 in FIG. 15g to prevent the point being used to apply any greater pressure. This therefore allows the reduction of the risk of injury being caused by inappropriate use of the etching means 258.

Once the child has scribed the image on the first sheet 254, that can be removed and a second sheet of material 254 is put into place and another image is scribed on that sheet. Once all the layers of sheet material 254 have been prepared, they are placed back into the drawing panel as indicated by arrows 268 in FIG. 15e to overlie each other and the same can be held in position via a frame holder 262. The body of the toy 250 includes a plurality of light sources therein, with at least one light source being positioned so as to illuminate each of the sheets of material, in their respective positions, in sequence, or altogether. This therefore allows the different features which have been formed by the user on the different sheets of material to be illuminated by the light sources such that the features which have been created by use of the etching means 258, are more clearly illuminated. In one embodiment, the user of the toy can provide an animated effect by the selective sequential illumination of the light sources, or alternatively one or more predetermined sequences of illumination of the light sources are provided in the toy control means.

FIGS. 16a and b illustrate a further aspect of the invention. In this case, there is provided a toy for use with a baby and the toy 270 includes a mirror display 272. However, also provided on the mirror surface or behind the same, is a sheet of material with etched features thereon which become viewable through the mirror by the selective illumination of light sources provided within the body 274 to illuminate the edge of the sheet material.

There is therefore provided in accordance with the invention a means by which light sources can be provided to generate an effective visual impression via illumination of predetermined features and also to allow additional play opportunities to be created for existing toys.

1. Apparatus having a display portion formed of sheet material, at least one light source located at an edge of the said sheet material and positioned such that, when illuminated, it passes light into the sheet material from said edge wherein said sheet material includes at least one feature which depends from a surface into the sheet material such as to cause a change of direction of said light at the location of said feature such that when said light source is illuminated, the visibility of said at least one feature is increased at said surface.

2. Apparatus according to claim 1 wherein the feature is created to pass into the sheet material from the surface thereof.

3. Apparatus according to claim 1 wherein the direction of the light is changed by the feature such that the light illuminates the feature and is externally viewable from at least one of the planar surfaces of the said sheet material.

4. Apparatus according to claim 1 wherein said sheet material is substantially optically transparent so as to allow light to pass therealong and through at least one of the planar surfaces at the location of which said at least one feature is provided.

5. Apparatus according to claim 1 wherein the feature is formed by removing at least a portion of material from one of the planar surfaces of the sheet material.

6. Apparatus according to claim 1 wherein a plurality of portions of sheet material are provided.

7. Apparatus according to claim 6 wherein the said portions of sheet material are placed side by side.

8. Apparatus according to claim 6 wherein, the portions of the sheet material are placed so as to overlie each other at least partially.

9. Apparatus to claim 6 wherein at least one light source is provided and positioned for each portion of sheet material.

10. Apparatus according to claim 9 wherein the light sources which are provided for the portions of sheet material are controlled such that the same are illuminated in a predefined manner and/or sequence.

11. Apparatus according to claim 10 wherein the light sources are illuminated to generate an animated effect, in conjunction with the features formed on the sheets of material.

12. Apparatus according to claim 11 wherein the features are provided on the portions of sheet material at specific locations to allow an animated effect to be achieved by sequential illumination of the light sources.

13. Apparatus according to claim 1 wherein a single light source is provided to be operated to provide different colours and/or intensity of light.

14. Apparatus according to claim 1 wherein a plurality of light sources are provided of different light intensity and/or colour.

15. Apparatus according to claim 1 wherein the sheet material is provided in a substantially flat form.

16. Apparatus according to claim 1 wherein the sheet material is provided in a three dimensional shape selected to allow light to pass along the same until a feature is reached.

17. Apparatus according to claim 1 wherein the feature or features are created on the sheet material by any or any, combination of machining, shot blasting, drilling, scoring, etching, texturing, extrusion and/or moulding.

18. Apparatus according to claim 1 wherein the one or more light sources for illumination of the sheet material are located so as to be hidden from view.

19. Apparatus according to claim 1 wherein packaging is formed at least partially by sheet material with at least one feature formed therein which is illuminated by at least one light source provided as part of the packaging.

20. Apparatus according to claim 19 wherein the selective operation of the at least one light source is possible while the packaging is part of a retail pack to allow the visual effect to be viewable by a person considering buying the retail pack and the contents therein.

21. A retail pack, said pack comprising an item for use, once purchased, and packaging in which said item is at least partially housed so as to form the retail pack, said packaging including at least a portion formed of overlaid first and second layers of sheet material, at least one of said sheets including a feature formed in a surface of the same, and at least one light source is provided which, when illuminated, passes light into at least one of said layers of sheet material so as to provide an illuminating effect on the at least one feature formed therein.

22. Apparatus according to claim 21 wherein a first set of light sources are provided to provide a lighting effect on a first layer of sheet material and a second set of light sources are provided to provide a lighting effect on a second layer of sheet material.

23. Apparatus according to claim 21 wherein the light sources are located as part of the packaging.

24. Apparatus according to claim 21 wherein the light sources are provided as part of and/or for use with the item located within the packaging.

25. Apparatus according to claim 24 wherein, the item can be provided in a first configuration to allow the light sources to be used with the packaging and a second configuration to allow the light sources to be used with the item.

26. Apparatus according to claim 21 wherein the packaging or item includes user actuation means such that, the user of the retail pack can operate the actuation means to cause the illumination of the packaging.

27. Apparatus including a display portion formed by at least first and second overlaid sheets of material, one or more light sources provided for selective illumination of one or more of the layers of the sheet material and wherein at least one of the sheets of material has at least one feature formed into a surface thereof and, the illumination of the one or more light sources for that layer of sheet material, cause the illumination of the at least one said feature so as to provide a visual effect.

28. Apparatus according to claim 27 wherein the item is in the form of a greetings card, or book.

29. Apparatus according to claim 27 wherein control means are provided so as to cause the selective illumination of at least one light source for each layer of the sheet material so as to provide an animated visual effect.

30. Apparatus according to claim 28 wherein the control means are operated by the movement of the greetings card or book from a closed position to an open position and in which open position, the layers of sheet material are visible.

31. Apparatus according to claim 1 wherein audio means are provided to be operated in conjunction with the illumination of the light sources so as to provide sound effects in addition to the visual effects.

32. Apparatus according to claim 31 wherein the sound effects are in sequence and synchronised with the visual effects which are created by the selective illumination of the light sources.

33. Apparatus having a display portion formed of at least one layer of sheet material, at least one light source located at an edge of the said at least one layer of sheet material and positioned such that, when illuminated, light is passed into the sheet material from said edge, said apparatus further including a means for forming a feature to a depth into the said sheet material and said feature, selectively formed and located on the sheet material by the user of the apparatus using the said means such that when said light source is illuminated, the visibility of the feature which has been formed, is increased at said surface.

34. Apparatus according to claim 33, wherein the means for creating the feature, is an etching tool which, when moved across the surface, causes a portion of the sheet material to be removed to create the feature to a shape defined by the user of the tool.

35. Apparatus according to claim 34 wherein the said tool includes an assembly which, when a pressure is exerted on the etching tip of the tool, exceeds a predetermined level, the etching tip is rendered unusable.

36. Apparatus according to claim 35 wherein the tip of the etching tool is rendered unusable by the same being retracted or withdrawn into the tool

37. Apparatus according to claim 33 wherein the display portion is formed from a plurality of sheets of material which selectively positioned one over the other to form the display to be illuminated and, prior to doing so, those layers of the sheet material which are required to have a feature formed thereon, can be positioned on the apparatus in conjunction with a stencil on which one or more features are depicted for the user to follow the lines of said depicted features with an etching tool on the layer of sheet material so as to form the features to that shape.
